(19) United States
(12) Patent Application Publication
(10) Pub. No.: US 2007/0164476 A1
(43) Pub. Date: Jul. 19, 2007

(54) CONTACT LITHOGRAPHY APPARATUS AND METHOD EMPLOYING SUBSTRATE DEFORMATION

(76) Inventors: Wei Wu, Mountain View, CA (US); William M. Tong, San Francisco, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/668,080

(22) Filed: Jan. 29, 2007

Related U.S. Application Data
(63) Continuation-in-part of application No. 10/931,672, filed on Sep. 1, 2004.

(51) Int. Cl. B29C 59/02

(52) U.S. Cl. 264/293; 425/385

(57) ABSTRACT

A contact lithography apparatus and a method of transferring a pattern to a surface employ deformation of a substrate for pattern transfer. The contact lithography apparatus includes a patterning tool and a substrate holder that variably retains a substrate. The substrate holder includes a plurality of retention zones. Each retention zone imparts a zone-specific retention force to the substrate that induces a deformation of the substrate toward the patterning tool. The method includes deforming the substrate. The deformation forms both an initial point of contact and a propagating contact front between the patterning tool and the substrate during pattern transfer.

### CROSS-REFERENCE TO RELATED APPLICATIONS

This application is a continuation-in-part of U.S. patent application Ser. No. 10/931,672, filed Sep. 1, 2004, the disclosure of which is incorporated herein by reference.

### BACKGROUND

1. Technical Field

The invention relates to semiconductors and the fabrication thereof. In particular, the invention relates to contact lithography used to define one or both of micro-scale and nano-scale structures during semiconductor fabrication.

2. Description of Related Art

Photographic contact lithography and imprint lithography are examples of two contact lithography methodologies for defining micro-scale and nano-scale structures that involve direct contact between a patterning tool (e.g., mask, mold, template, etc.) and a substrate on which the structures are to be fabricated. In particular, during photographic contact lithography, the patterning tool (i.e., mask) is aligned with and then brought in contact with the substrate or a receiving surface of the substrate. The pattern is then transferred to the receiving surface layer using a photographic technique such as illuminating the patterning tool and the receiving surface with a radiation source (e.g., ultraviolet light, an electron beam, X-ray radiation, etc.) Similarly, in imprint lithography, the patterning tool (i.e., mold) is aligned with the substrate after which the pattern is printed on or impressed into the receiving surface of the substrate through a direct contact between the mold and the receiving surface.

In both of photographic contact lithography and imprint lithography, alignment between the patterning tool and the substrate general involves holding the patterning tool a small distance above the substrate while lateral and rotational adjustments (e.g., x-y translation and/or angular rotation) are made to a relative position of the tool and/or the substrate. The patterning tool is then brought into intimate contact with the substrate. As the patterning tool contacts the substrate, gas bubbles may be trapped at an interface between the patterning tool and the substrate. Trapped gas bubbles adversely affect patterning by introducing defects in the transferred pattern. Methods of eliminating gas bubbles or mitigating their effects include, but are not limited to, using relative high contact pressure and employing materials that are either gas absorbing or gas permeable for one or both of the patterning tool and a substrate receiving layer. The use of high contact pressure and being restricted to using gas absorbing and/or gas permeable materials may limit the applicability and ultimate marketability of contact lithography, especially for nano-scale fabrication. Moreover, requiring the use of high contact pressures may limit using conventional tools and systems such as a conventional mask aligner for performing the contact lithography.

### BRIEF SUMMARY

In some embodiments of the present invention, a contact lithography apparatus is provided. The contact lithography apparatus comprises a substrate holder that variably retains a substrate on the substrate holder. The substrate holder comprises a plurality of retention zones. Each retention zone of the plurality imparts a zone-specific retention force to the substrate. The contact lithography apparatus further comprises a patterning tool having a pattern adjacent to a receiving surface of the substrate. The zone-specific retention forces imparted by the plurality of retention zones induce a deformation of the substrate toward the patterning tool. The deformation forms both an initial point of contact and a propagating contact front between the patterning tool and the substrate during transfer of the pattern to the substrate.

In other embodiments of the present invention, a contact lithography apparatus is provided. The contact lithography apparatus comprises a first plate that supports a patterning tool having a pattern and a second plate spaced apart from the first plate. The second plate comprises a plurality of retention zones. The retention zones variably retain a substrate to the second plate. The substrate has a receiving surface. The contact lithography apparatus further comprises a gasket that bridges a perimeter of a space between the first plate and the second plate to form a chamber with an internal cavity that encloses the patterning tool and the substrate. The chamber is compressible to transfer the pattern to the receiving surface such that the patterning tool is pressed against and contacts the substrate. The retention zones collectively induce a deformation of the substrate that results in an initial contact point between the patterning tool and the substrate. The initial contact point becomes a propagating contact front during chamber compression.

In other embodiments of the present invention, a method of transferring a pattern to a surface is provided. The method comprises establishing a proximal, spaced apart arrangement of a patterning tool and a substrate. The method of transferring further comprises deforming the substrate toward the patterning tool to form an initial point of contact between the patterning tool and the substrate. Deforming the substrate comprises reducing a retention force of a first zone of a substrate holder relative to a retention force of a second zone of the substrate holder. The method of transferring further comprises propagating a contact front between the patterning tool and the substrate. The contact front propagates away from the initial point of contact toward a perimeter of the substrate. The propagating contact front transfers the pattern of the patterning tool onto the substrate.

Certain embodiments of the present invention have other features in addition to and in lieu of the features described hereinabove. These and other features of the invention are detailed below with reference to the following drawings.

### BRIEF DESCRIPTION OF THE DRAWINGS

The various features of embodiments of the present invention may be more readily understood with reference to the following detailed description taken in conjunction with the accompanying drawings, where like reference numerals designate like structural elements, and in which:

FIG. 1 illustrates a cross sectional view of a contact lithography apparatus according to an embodiment of the present invention.

FIGS. 2A-2C illustrate a cross-sectional view of the contact lithography apparatus of FIG. 1 during a sequence of stages of an exemplary contact lithography according to an embodiment of the present invention.

FIG. 2D illustrates a cross-sectional view of a contact lithography apparatus after the contact front has propagated to the periphery of the substrate, according to another embodiment of the present invention.

FIG. 3 illustrates a cross-sectional view of a contact lithography apparatus according to another embodiment of the present invention.

FIG. 4 illustrates a cross-sectional view of a contact lithography apparatus according to another embodiment of the present invention.

FIG. 5 illustrates a block diagram of an imprint lithography system according to an embodiment of the present invention.

FIG. 6 illustrates a flow chart of a method of transferring a pattern to a surface according to an embodiment of the present invention.

### DETAILED DESCRIPTION

Embodiments of the present invention facilitate contact lithography wherein a pattern defined by a patterning tool is transferred to, imprinted on or pressed into a surface of a sample or substrate. In particular, a pressure applied to one or both of the patterning tool and the substrate produces a direct physical contact between the patterning tool and the substrate. The applied pressure presses at least one protruding feature of the patterning tool pattern onto or into a receiving surface of the substrate. As a result of the pressure-induced contact during contact lithography, a negative image copy of the patterning tool pattern is created on or in the receiving surface.

According to the embodiments of the present invention, application of the pressure during contact lithography establishes an initial contact point between the patterning tool and the substrate. Furthermore according to various embodiments of the present invention, the initial contact point occurs at a predetermined location on the substrate. After formation of the initial contact point, continued application of the pressure produces a contact front that propagates away from the initial contact point. The contact front represents and is defined as a boundary between a portion of the patterning tool and substrate that is in direct contact and other portions of the patterning tool and substrate that are not yet in contact. The contact front ultimately spreads or propagates to an edge of one or both of the patterning tool and the substrate at which point the patterning tool and the substrate are in uniform contact with one another. The initial contact point and a propagating contact front facilitate evacuation and elimination of gas from between the patterning tool and the substrate that may otherwise have been trapped as bubbles therebetween, according to some embodiments. Further, by inverting a propagation direction of contact front following pattern transfer, separation of the patterning tool and the substrate may be facilitated.

The initial contact point is produced in the predetermined location and in a controlled manner by a deformation of the substrate during contact lithography, according to the embodiments of the present invention. In particular, the deformation of the substrate is induced to occur at the predetermined location on the substrate and is in a direction toward the patterning tool. As such, when the patterning tool approaches the substrate during contact lithography, the patterning tool initially contacts the substrate at a point of maximum deformation (i.e., a deformation maximum) in a vicinity of the predetermined location. The deformation maximum, in turn, determines the predetermined location of the initial contact point.

The deformation of the substrate is facilitated by a substrate chuck or holder comprising a plurality of retention zones. Acting together, the retention zones of the plurality hold or retain the substrate on the substrate holder. Each retention zone of the plurality imparts to the substrate a zone-specific retention force. Zone-specific retention forces of individual retention zones can and do differ from one another. As such, the plurality of retention zones variably retains the substrate on a zone-wise basis by virtue of the differing zone-specific retention forces.

The variable retention provided by the plurality of retention zones facilitates producing the deformation of the substrate. In particular, a retention zone near the deformation maximum imparts a lower retention force than a retention zone located away from the deformation maximum. The lower retention force of the nearer zone relative to the zone located away from the deformation maximum facilitates the deformation when a deformation force is applied to the substrate. The relatively higher retention force provided by the retention zone(s) located away from the deformation maximum facilitates retention of the substrate during deformation.

In some embodiments, a pressure difference across the substrate acting in conjunction with the variable retention of the substrate holder provides the deformation force that induces the deformation. For example, the applied pressure used for transferring the pattern may result from a difference in a pressure inside of and a pressure outside of a compressible chamber that houses the patterning tool and the substrate. The pressure difference acting in conjunction with the variable retention of the plurality of retention zones induces the deformation of the substrate. In some embodiments, the contact front radiates or propagates to a periphery of the substrate as the compressible chamber presses the patterning tool and the substrate together to provide a uniform contact between the patterning tool and the substrate.

In other embodiments, the deformation force is provided by an extensible pin or equivalent mechanical means for providing a deformation force. For example, the extensible pin may extend beneath the substrate to press against a back side of the substrate and induce the deformation toward the patterning tool. The extensible pin may be extended by action of a piston, for example. The retention zone associated with the extensible pin thus imparts a lower zone-specific retention force (e.g., negative retention force) than another retention zone located away from the pin. As a result, a bulge-like deformation is produced in the substrate in a vicinity of the extended pin while the substrate is held tightly to the substrate holder away from the pin, for example.

Embodiments of the present invention are generally applicable to contact lithography used for, but not limited to, fabrication of micro-scale and nano-scale structures (e.g., semiconductor fabrication). A nano-scale structure typically has dimensions that are on the order of 100 nanometers (nm) or less. Nano-scale structures are often 50 to 100 times smaller than conventional, so-called ‘micro-scale’ structures that are produced by micro-imprint lithography, for example.

Herein, the term ‘deformation’ generally includes within its scope one or both of a plastic deformation and an elastic deformation. Herein, the term ‘deformation’ further generally includes within its scope one or both of a passive deformation and an active deformation. Further herein, the term ‘flexure’ has the same meaning as ‘deformation’ and the terms are used interchangeably as are ‘flex’ and ‘deform’; ‘flexible’ and ‘deformable’; and ‘flexing’ and ‘deforming’, or the like.

Herein, the term ‘contact lithography’ is generally defined as essentially any lithographic methodology that employs a direct or physical contact between means for providing a pattern or the patterning tool and means for receiving the pattern or the substrate, including a substrate having a receiving surface or layer, without limitation. Specifically, ‘contact lithography’ as used herein includes, but is not limited to, various forms of photographic contact lithography, X-ray contact lithography, and imprint lithography. Imprint lithography includes, but is not limited to, micro-imprint lithography and nano-imprint or nano-scale imprint lithography (NIL) and combinations thereof.

For example, in photographic contact lithography, a physical contact is established between a photomask (i.e., the patterning tool) and a photosensitive resist layer on the substrate (i.e., the pattern receiving means). During the physical contact, visible light, ultraviolet (UV) light, or another form of radiation passing through the photomask exposes the photoresist. As a result, a pattern of the photomask is transferred to the substrate.

In imprint lithography, a mold (i.e., the patterning tool) transfers a pattern to the substrate through an imprinting process. For example, a physical contact between the mold and a layer of formable or imprintable material on the substrate (i.e., the pattern receiving means or receiving surface layer material), transfers the pattern to the substrate. The imprintable material may be a material of the substrate itself that is relatively softer than the mold, for example. In another example, the receiving surface or layer comprises a layer of the relatively softer material applied over a relatively harder substrate material. For example, the substrate may comprise one or more of a semiconductor material, a dielectric material, and metal material to which the relatively softer material is applied. In either case, the relatively softer material receives and retains the imprinted pattern after the mold is removed and during further processing. A surface of the softer material that receives the mold during imprinting is referred to herein as the ‘receiving surface’ or ‘receiving layer’ of the substrate.

In some embodiments, the relatively softer material is cured or hardened during imprinting to facilitate retention of the imprinted pattern. Curing essentially ‘freezes’ or fixes the receiving layer in a shape or pattern determined by the mold. As used herein ‘curing’ generally includes any means of improving imprint retention especially a means that is selectively initiated or activated during imprinting.

For example, a layer of a photo-curable material such as, but not limited to, a photo-activated monomer, oligomer, or polymer, (e.g., photoresist) that hardens when exposed to light (e.g., infrared, visible or ultraviolet (UV) illumination) may be used as the receiving layer. Prior to curing, the photo-curable material is soft (e.g., liquid or semi-liquid) and readily accepts the mold imprint pattern. Upon exposure to light, the photo-curable material cures around the mold. The cured photo-curable material thus retains the imprint pattern of the mold.

In another example, a thermoplastic material applied as a layer or film to a surface of the substrate is used as the receiving surface. Prior to imprinting, the thermoplastic material layer is heated to about a glass transition temperature of the material, thereby softening the material. The mold is pressed into the softened material and the material is cooled to below the glass transition temperature causing the material to harden or cure around the impressed mold. The imprinted pattern is retained by the cured thermoplastic material. Examples of thermoplastic polymers that are used as the receiving layer include, but not limited to, polycarbonate, polymethylmethacrylate (PMMA) and methylmethacrylate (MMA).

For simplicity herein, no distinction is made between the substrate and any receiving surface layer or structure on the substrate (e.g., photoresist layer or imprintable material layer) unless such a distinction is necessary for proper understanding. As such, the means for receiving a pattern is generally referred to herein as a ‘substrate’ irrespective of whether a resist layer or other formable material layer may be employed on the substrate to receive the pattern. Moreover, the patterning tool (e.g., photomask, X-ray mask, imprint mold, template, etc.) also may be referred to herein as either a ‘mold’ or a ‘mask’ for simplicity of discussion and not by way of limitation. Examples described herein are provided for illustrative purposes only and not by way of limitation. Moreover, the term ‘imprint’ or ‘imprinting’ is used herein interchangeable for the various types of contact lithography, and is not limited herein to imprint lithography. In particular, the verbs ‘imprint’ and ‘transfer’ are used interchangeably below unless a distinction is necessary for proper understanding.

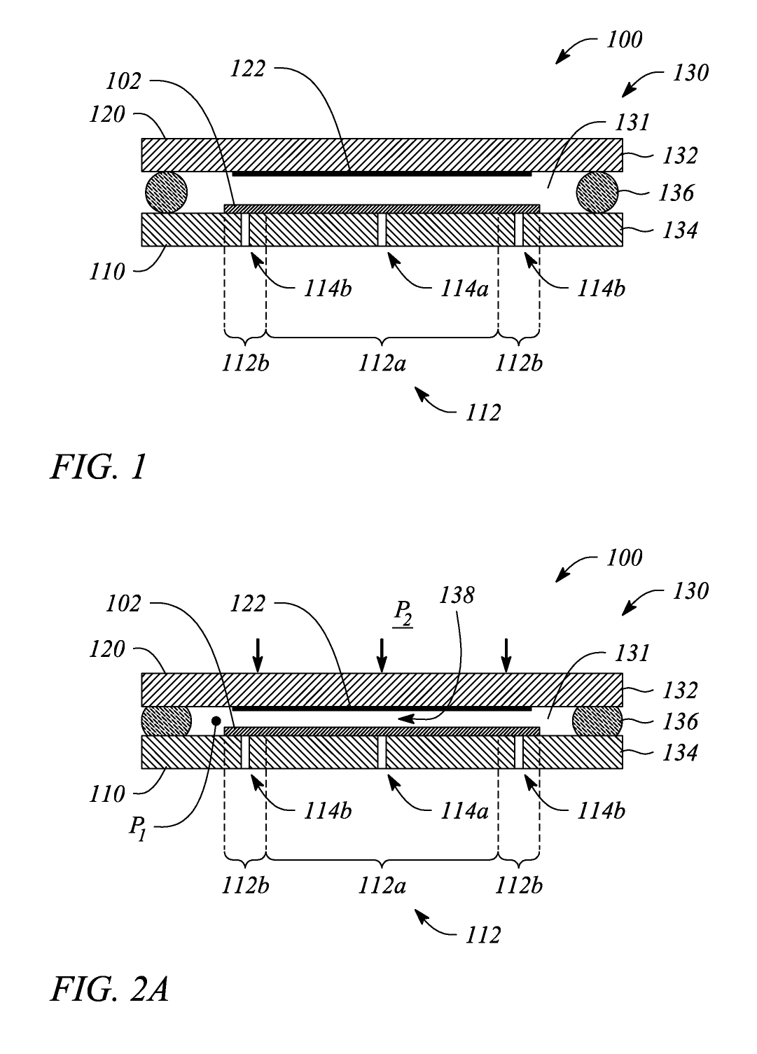

FIG. 1 illustrates a cross sectional view of a contact lithography apparatus 100 according to an embodiment of the present invention. The contact lithography apparatus 100 is employed to transfer a pattern onto a substrate 102 using contact lithography. In particular, the contact lithography apparatus 100 induces a deformation of the substrate 102 during contact lithography to facilitate pattern transfer.

As illustrated in FIG. 1, the contact lithography apparatus 100 comprises a substrate chuck or substrate holder 110. The substrate holder 110 variably retains the substrate 102 on a surface of the substrate holder 110. By ‘variably retains’ it is meant that the substrate holder 110 holds or retains some portions of the substrate 102 more tightly or with a greater retention force than other portions. In some embodiments, the variable retention is selectively controlled and may be changed during contact lithography.

The substrate holder 110 comprises a plurality of retention zones 112. By way of example, a first retention zone 112a illustrated in FIG. 1 comprises a circular area in a vicinity of a center or middle of the substrate holder 110. A second retention zone 112b illustrated in FIG. 1 comprises an annular region outside of and surrounding the first retention zone 112a. While only two retention zones 112 are illustrated in FIG. 1, the substrate holder 110 may comprise three, four or more retention zones 112. For example, a third retention zone (not illustrated) may comprise an annular region outside of and surrounding the second retention zone 112b.

Each retention zone 112 of the plurality imparts to the substrate 102 a zone-specific retention force. In some embodiments, the zone-specific retention force of each retention zone 112 is provided by a separate vacuum source (not illustrated). The separate vacuum sources of the retention zones 112 provide separate retention pressures (PRs) to the retention zones 112. Herein, a ‘retention pressure’ PR is generally less than an ambient pressure P_{ambient} or another pressure (e.g., P₁) appropriate for a given situation being described.

The separate retention pressures act to hold the substrate 102 to the substrate holder 110 by virtue of a force created by a pressure difference. In particular, the pressure difference is a difference between an ambient pressure P_{ambient} on a side of the substrate 102 facing away from the substrate holder 110 and the retention pressure(s) PR provided by the vacuum sources to a side of the substrate 102 adjacent to the substrate holder 110.

For example, a first vacuum source may be connected to the first retention zone 112a by a first vacuum port 114a in the substrate holder 110. The first vacuum source produces a first retention pressure PRₐ, for example. A second vacuum source may be connected to the second retention zone 112b by a second vacuum port 114b in the substrate holder 110. The second vacuum source produces a second retention pressure PR_{b}, for example. Each of the first retention pressure PRₐ and the second retention pressure PR_{b} creates a separate pressure difference in conjunction with the ambient pressure P_{ambient} that results in separate retention force being applied to the substrate in each of the first and second retention zones 112a, 112b, respectively.

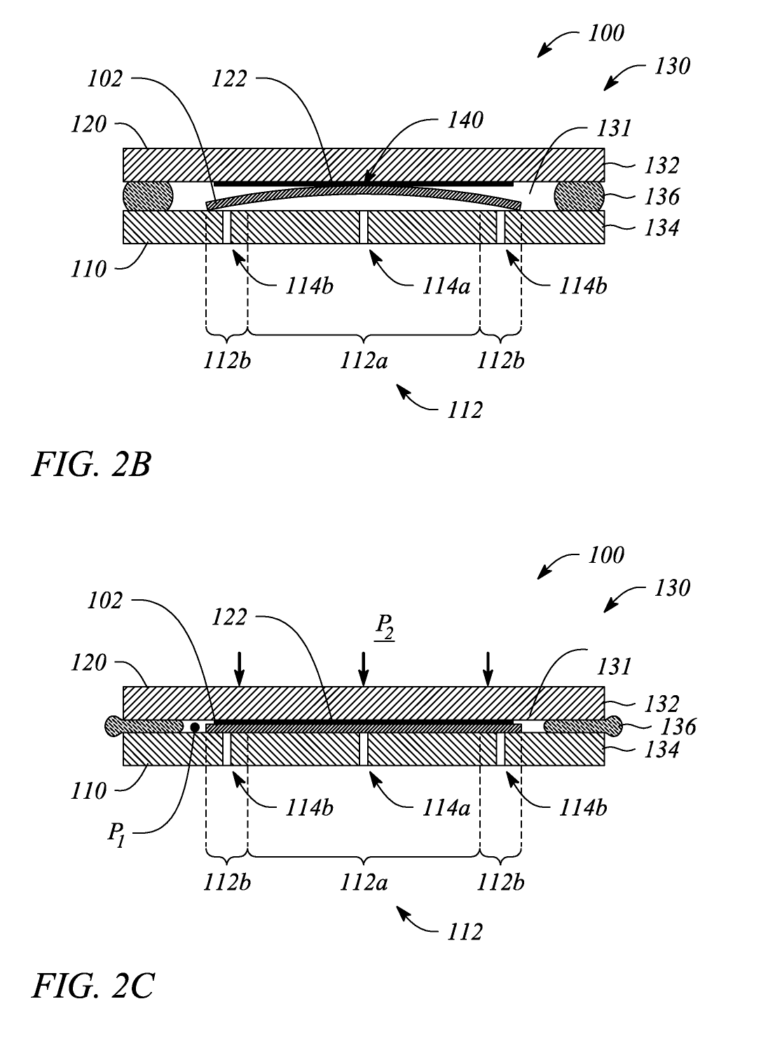

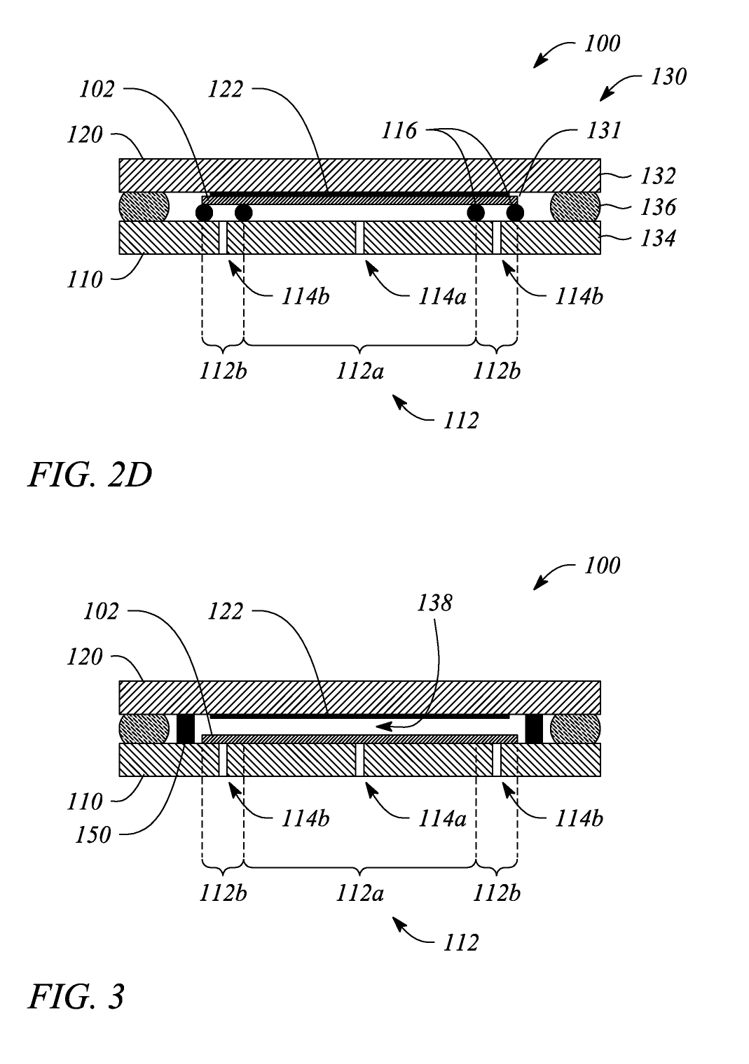

When retention pressure PR is employed to provide the retention forces, means for separating a retention zone including, but not limited to, an o-ring or a similar gasket structure (e.g., gaskets 116 illustrated in FIG. 2D, for example), may be employed to separate the retention zones 112. Similarly, means for separating a retention zone (not illustrated) may be employed at a periphery of the substrate 102 to separate the plurality of retention zones 112 from an ambient environment on the side of the substrate 102 facing away from the substrate holder 110.

In some embodiments, the zone-specific retention force of the first retention zone 112a is less than the zone-specific retention force of the second retention zone 112b. In some embodiments, the zone-specific retention force of the first retention zone 112a is less than the zone-specific retention forces of all other retentions zones 112. In some embodiments the zone-specific retention force of the first retention zone 112a is much less than the retention forces of all other retention zones. In some embodiments, the zone-specific retention force of the second retention zone 112b is less than the zone-specific retention force of all other retention zones 112 except the first retention zone 112a. Individual zone-specific retention forces of the retention zones 112 may be altered or changed during contact lithography. In some embodiments, retention zones (e.g., 112b) exert a retention force sufficient to hold the substrate 102 firmly to the substrate holder 110 during deformation.

The contact lithography apparatus 100 further comprises a patterning tool 120 having a pattern adjacent to a receiving surface of the substrate 102. The patterning tool 120 carries the pattern 122 that is transferred to (e.g., imprinted on) the substrate 102. The patterning tool 120 may comprise essentially any patterning tool used in contact lithography including, but not limited to, those described above. For example, the patterning tool 120 may comprise a mold 120 having a mold pattern that is impressed into the substrate 102 during contact lithography.

In the embodiment illustrated in FIG. 1, the contact lithography apparatus 100 further comprises a compressible chamber 130 having a cavity 131. The compressible chamber 130 generally encompasses the substrate holder 110 and the patterning tool 120 and encloses the substrate 102 being held by the substrate holder 110, as illustrated. The compressible chamber 130 is further described below.

A compression of the compressible chamber 130 brings the patterning tool 120 in contact with the substrate 102. Further compression of the chamber 130 presses the patterning tool 120 into the receiving surface of the substrate 102 to transfer the pattern 122 of the pattering tool 120 onto the substrate 102. In some embodiments, a pressure difference between a pressure P₁ inside the chamber 130 and a pressure P₂ outside the chamber 130, compresses the chamber 130 to provide pattern transfer. In some embodiments, the pressure difference further induces the deformation of the substrate 102 as is further described below with respect to FIG. 2A.

In general, the compressible chamber 130 is defined by a first or top member or plate 132, a second or bottom member or plate 134, and a seal or gasket 136. The top member 132 is spaced apart from the bottom member 134. The gasket 136 bridges or spans a perimeter of the space between the members 132, 134 to ‘complete’ the compressible chamber 130. The completed compressible chamber 130 defines the cavity 131. One or both of the top member 132 and the bottom member 134 may be moveable relative to an external reference frame (not illustrated). The chamber 130 is compressed by a relative motion of the top member 132 and the bottom member 134 toward one another. The top member 132 supports the patterning tool 120 and the bottom member 134 supports the substrate holder 110 in an opposing relationship within the chamber 130.

In some embodiments (e.g., as illustrated in FIG. 1), the compressible chamber 130 comprises the substrate holder 110, the patterning tool 120, and the compressible gasket 136. In particular, the bottom member 134 of the compressible chamber 130 comprises the substrate holder 110, the top member 132 of the compressible chamber 130 comprises the patterning tool 120, and the compressible gasket 136 is disposed between and connects or bridges between the substrate holder 110 and patterning tool 120 to form the compressible chamber 130.

In some embodiments, one or both of the members 132, 134 are optically transparent to facilitate optical alignment between the patterning tool 120 and substrate 102. Exemplary materials for the members 132, 134 include, but are not limited to, quartz, various types of glass, and silicon carbide (SiC). In some embodiments, only the top member 132 is transparent while the bottom member 134 has no specific transparency requirements. In such embodiments, the bottom member 134 may comprise essentially any material including, but not limited to, silicon (Si), quartz, glass, gallium arsenide (GaAs), another semiconductor material, ceramic, and metal.

In general, the shape of the members 132, 134 is unimportant and is generally dictated by the specific application or environment (e.g., lithography system, patterning tool 120, substrate 102, etc.). As such, the members 132, 134 may be round, square, hexagonal or essentially any other shape that accommodates the substrate holder 110, the substrate 102, and the patterning tool 120. In some embodiments, symmetric shapes such as round or square plates are employed for the members 132, 134. Also, in some embodiments, the members 132, 134 have an essentially uniform thickness and each member 132, 134 provides at least one relatively flat surface to which the patterning tool 120 and substrate holder 110 are respectively mounted. In some embodiments, the compressible chamber 130 is essentially similar to and is used for contact lithography in a manner described in co-pending U.S. patent application Ser. No. 10/931,672, incorporated herein by reference in its entirety.

Generally, the gasket 136 is essentially impermeable to one or both of gas and liquid (hereafter ‘fluid’). Thus, the gasket 136 along with the top and bottom members 132, 134 of the compressible chamber 130 may serve to separate a fluid within the cavity 131 of the chamber 130 from another fluid outside the chamber 130. In particular, the fluid within the chamber 130 may be at a pressure that differs from that of the fluid outside the chamber 130. For example, the fluid inside the chamber 130 may be air at a first or cavity pressure P₁ and the fluid outside the chamber 130 may be air at a second pressure P₂.

In some embodiments, the gasket 136 comprises a compressible material or a semi-compressible material. In such embodiments, the compressible gasket 136 readily compresses during compression of the chamber 130. For example, the gasket 136 may comprise a material such as, but not limited to, silicone, latex, neoprene, and butyl rubber. In such embodiments, the compressible gasket 136 may effectively define or delineate a side or sides of the compressible chamber 130 while the top member 132 and bottom member 134 form a top and a bottom of the chamber 130, respectively.

For example, the compressible gasket 136 may comprise a silicone ‘o-ring’. In another example, the gasket 136 may be an elastomeric sheet having an opening or space cut in a central portion of the sheet to form a space for the cavity 131 of the chamber 130. In another example, the gasket 136 may be applied to one or both of the top member 132 and the bottom member 134 as a liquid or semi-liquid that is cured or ‘hardened’ once applied (e.g., silicone or acrylic caulking) to form the compressible gasket 136. In yet another example, the gasket 136 may be made of a plurality of materials, some of which are compressible while others are essentially incompressible.

The gasket 136 may be affixed to one of the members 132, 134 with an adhesive or another means of adhesion, or may be essentially free floating between the members 132, 134 until compressed. Alternatively, the gasket 136 may be retained or positioned between the members 132, 134 in a groove or similar feature defined in an adjacent surface of one or both of the members 132, 134.

In other embodiments (not illustrated), the gasket is essentially non-compressible. For example, the top member and the bottom member may be configured to nest inside one another as a piston nests inside a cylinder. In such embodiments, the gasket essentially slides on a surface of one or both of the top and bottom members during chamber compression (e.g., rings of a piston), but does not itself compress.

FIGS. 2A-2C illustrate a cross-sectional view of the contact lithography apparatus 100 of FIG. 1 during a sequence of stages of an exemplary contact lithography according to an embodiment of the present invention. In particular, the contact lithography apparatus 100 illustrated in FIGS. 2A-2C comprises the compressible chamber 130 that encloses the substrate 102 and the patterning tool 120 wherein the patterning tool 120 is integral with the top member 132 of the compressible chamber 130 and the substrate holder 110 forms the bottom member 134 thereof. The substrate holder 110 variably retains the substrate 102 using retention pressure PR applied to the vacuum ports 114a, 114b of the substrate holder 110.

At a beginning of the sequence, the contact lithography apparatus 100 appears essentially as illustrated in FIG. 1. In particular, the compressible chamber 130 is created by bringing the top member 132 and the substrate holder 110 (i.e., bottom member 134) in mutual contact with the compressible gasket 136. The cavity pressure P₁ inside the cavity 131 and the second pressure P₂ outside the cavity 131 are essentially equal to the ambient pressure P_{ambient} (i.e., P₁=P₂=P_{ambient}). The first retention pressure PRₐ of the first retention zone 112a and the second retention pressure PR_{b} of the second retention zone 112b are both less than P_{ambient} to insure that the substrate 102 is held securely in place on the substrate holder 110. In some embodiments, a relative alignment of the patterning tool 120 and the substrate 102 is achieved prior to forming the compressible chamber 130.

FIG. 2A illustrates the contact lithography apparatus 100 after the cavity pressure P₁ has been reduced relative to the second pressure P₂ creating a pressure difference, according to an embodiment of the present invention. The pressure difference results in a compression force indicated by bold arrows in FIG. 2A being applied to the compressible chamber 130. The compression force begins to collapse the compressible chamber 130 by compressing the gasket 136. As illustrated in FIG. 2A, spacing between the patterning tool 120 and the substrate 102 has been reduced to form a gap 138. In some embodiments, compression of the compressible chamber 130 is halted when a target extent of the gap 138 is achieved. For example, the target extent of the gap 138 may be about 1 micron (μm). The first and second retention pressures PRₐ, PR_{b} are both less than the cavity pressure P₁, as illustrated in FIG. 2A. Thus, the substrate 102 is still securely held by the substrate holder 110 even if the cavity pressure P₁ is less than the ambient pressure P_{ambient}, for example.

FIG. 2B illustrates the contact lithography apparatus 100 during formation of an initial contact point 140 between the substrate 102 and the patterning tool 120, according to an embodiment of the present invention. In particular, the first retention pressure PRₐ of the first retention zone 112a is increased to be greater than the cavity pressure P₁ to produce a pressure difference across the substrate 102 in a vicinity of the first retention zone 112a. As a result, the substrate holder 110 retains the substrate 102 with a lower zone-specific retention force at the first retention zone 112a than at the second retention zone 112b. Additionally, the pressure difference across the substrate 102 results in a force that deforms the substrate 102 toward the patterning tool 120 and away from the substrate holder 110. As illustrated in FIG. 2B, a bulge-like deformation is caused in the substrate 102 above the first retention zone 112a. The bulge-like deformation increases until the substrate 102 contacts the patterning tool 120. The first point of contact between the substrate 102 and the patterning tool 120 is the initial contact point 140 illustrated in FIG. 2B.

In some embodiments, the substrate 102 deforms further after formation of the initial contact point 140 such that the initial contact point 140 is effectively expanded into a contact front (not illustrated) that propagates away from the initial contact point 140 toward a periphery of the substrate 102. In other embodiments, a spacing between the patterning tool 120 and the substrate holder 110 is further reduced after the formation of the initial contact point 140. The reduction of the spacing expands the initial contact point 140 into the propagating contact front in a manner similar to that produced by the further deformation. In some embodiments, both further deformation and further reduction in the spacing one or both of produce and expand the propagating contact front.

FIG. 2C illustrates the contact lithography apparatus 100 after the contact front has propagated to the periphery of the substrate 102, according to an embodiment of the present invention. Specifically, as illustrated in FIG. 2C, the substrate 102 and patterning tool 120 are essentially in uniform contact across an entire area of the pattern 122 of the patterning tool 120. In some embodiments, the cavity pressure P₁ is reduced to much less than the outside pressure and preferably about zero (e.g., P₁˜0 Torr) to provide the uniform contact. For example, the pressure difference between the cavity pressure P₁ and the second pressure P₂ outside the cavity 131 may be sufficient to essentially completely compress the compressible chamber 130 and provide the uniform contact, as illustrated in FIG. 2C.

In some embodiments, the first retention pressure PRₐ and the second retention pressure PR_{b} are increased relative to the cavity pressure P₁ provide the uniform contact instead of or in addition to reducing the cavity pressure P₁. For example, the first and second retention pressures PRₐ, PR_{b} may both be increased to essentially the outside pressure P₂. The pressure difference thus created across the substrate 102 uniformly presses the substrate 102 against the patterning tool 120.

FIG. 2D illustrates another embodiment of the contact lithography apparatus 100 after the contact front has propagated to the periphery of the substrate 102, according to an embodiment of the present invention. In particular, FIG. 2D illustrates an embodiment in which an increase in both the first and second retention pressures PRₐ, PR_{b} provides the force for establishing the uniform contact between the patterning tool 120 and the substrate 102. As illustrated in FIG. 2D, the compressible cavity is not completely compressed as opposed to that illustrated in FIG. 2C. Instead, the pressure difference between the cavity pressure P₁ and the combined first and second retention pressures PRₐ, PR_{b} presses the substrate 102 into uniform contact with the patterning tool 120. In the embodiment illustrated in FIG. 2D, the spacing between the substrate holder 110 and the patterning tool 120 used to establish the gap 138 is generally maintained and the substrate 102 is pressed against the patterning tool 120 to propagate the contact front and complete the pattern transfer.

Also illustrated in FIG. 2D are o-rings 116 used to separate retention zones 112a and 112b (omitted from FIGS. 1 and 2A-2C for clarity). In the embodiment illustrated in FIG. 2D, the o-rings 116 also function to expand in response to a pressure difference. As illustrated in FIG. 2D, the o-rings 116 are expanded under the substrate 102 to maintain the separation between the retention zones 112 as the substrate 102 is pressed against the patterning tool 120 by the pressure difference. In some embodiments, the o-rings 116 further separate the cavity 131 from the retention zones 112 to maintain the pressure difference between the retention pressure PRₐ, PR_{b} of the retention zones 112 and the cavity pressure P₁.

Referring again to FIG. 2A, as mentioned above, the gap 138 between the patterning tool 120 and the substrate 102 facilitates formation of the initial contact point 140 during substrate deformation. In various embodiments, the target size of the gap 138 is generally less than or equal to an amount that the substrate 102 is deformed by the contact lithography apparatus 100. In some embodiments, the target size of the gap 138 is less than or equal to a thickness of the substrate 102. In some embodiments, the target size of the gap 138 is less than about 10 μm. In other embodiments, the target size of the gap is less than about 2 μm and preferably is about 1 μm.

In some embodiments, the spacing between the substrate holder 110 and patterning tool 120 that establishes the gap 138 is provided by an external system such as a mask aligner (not illustrated). For example, the mask aligner may hold the top member 132 and the bottom member 134 of the compressible cavity during contact lithography and constrain a relative movement of the top and bottom members 132, 134 to establish the gap 138. Specifically, the mask aligner may allow the top member 132 and the bottom member 134 to approach one another until the target size of the gap 138 between the patterning tool 120 and the substrate 102 is established at about 1 μm. When the target size is achieved, the mask aligner prevents a further reduction of the overall spacing between the patterning tool 120 and the substrate holder 110 to maintain the spacing and establish the gap 138.

In other embodiments, the contact lithography apparatus 100 further comprises a spacer that maintains the spacing and establishes the gap 138. FIG. 3 illustrates a cross-sectional view of a contact lithography apparatus 100 further comprising a spacer 150, according to another embodiment of the present invention. As illustrated, the spacer 150 is disposed between the substrate holder 110 and the patterning tool 120. The spacer establishes a minimum spacing distance between the substrate holder 110 and the patterning tool 120 such that the gap 138 is provided. In particular, the spacer 150 stops the substrate holder 110 and the patterning tool 120 from approaching one another such that the target size of the gap 138 is achieved that is equivalent to that illustrated in FIG. 2A.

In some embodiments (not illustrated), the cavity 131 may be omitted or the cavity pressure may be maintained at about ambient pressure P_{ambient}. In such embodiments, another force such as a mechanical or hydraulic force may be used to press the patterning tool 120 into the substrate 102. The deformation of the substrate 102 can still be produced by appropriate values of the first and second retention pressures PRₐ, PR_{b}. For example, the first retention pressure PRₐ may be increased to be greater than the ambient pressure P_{ambient} to create a pressure difference across the substrate 102 and induce deformation. Likewise, after formation of the initial contact point 140, the second retention pressure PR_{b} may be increased to be greater than the ambient pressure P_{ambient} to propagate the contact front and complete the pattern transfer. Alternatively or in addition, the force such as the mechanical or hydraulic force can be used to propagate the contact front and complete the pattern transfer.

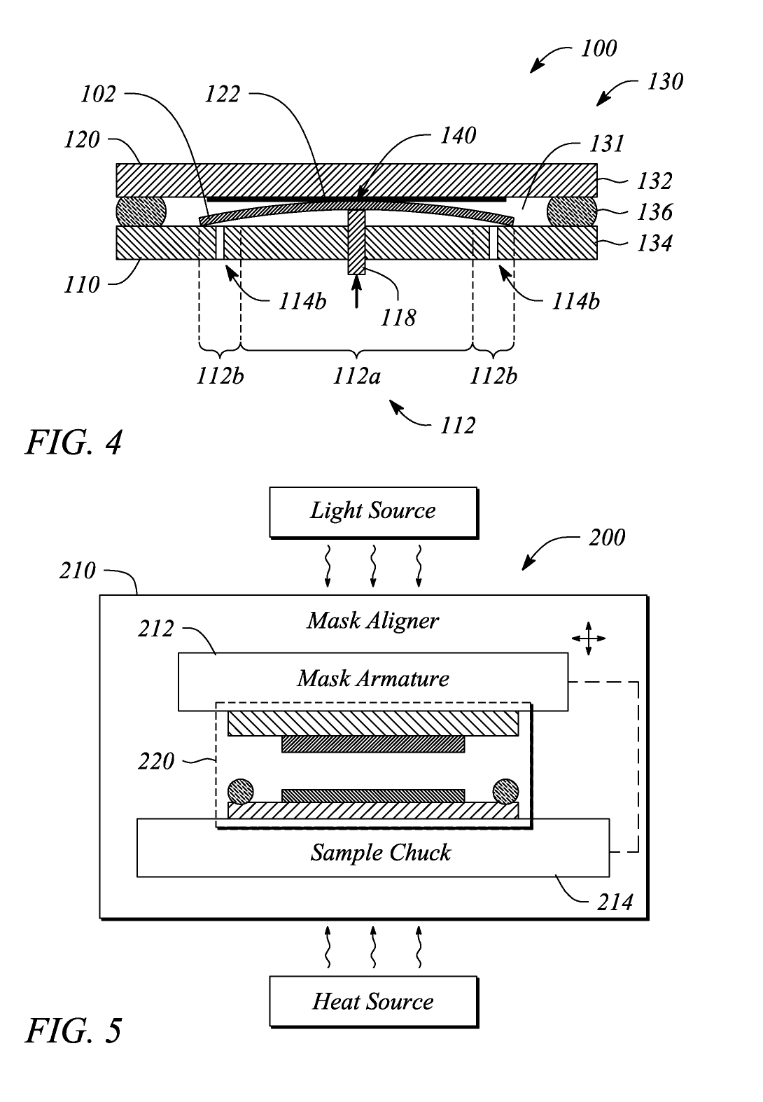

FIG. 4 illustrates a cross-sectional view of the contact lithography apparatus 100 according to another embodiment of the present invention. The contact lithography apparatus 100 comprises the patterning tool 120, the substrate holder 110, vacuum ports 114b and the plurality of retention zones 112, all as described above for the contact lithography apparatus 100 illustrated in FIG. 1. The contact lithography apparatus 100 of FIG. 4 further comprises an extensible pin 118 through the substrate holder 110. FIG. 4 illustrates the extensible pin 118 in an extended configuration through the substrate holder 110 in lieu of the vacuum port 114a of FIG. 1.

During contact lithography, the extensible pin 118 is extended in a direction toward the patterning tool 120 to deform the substrate 102 and produce the initial contact point 140. The contact lithography apparatus 100 illustrated in FIG. 4 provides the substrate 102 deformation during contact lithography without the use of the compressible chamber 130 describe above for the contact lithography apparatus 100 of FIG. 1. However, the contact lithography apparatus 100 comprising the extensible pin 118 may be also used in conjunction with the compressible chamber 130 describe above, according to some embodiments. Therefore, FIG. 4 further illustrates the elements 131, 132, 134 and 136 of the compressible chamber 130 in accordance with some embodiments.

The extensible pin 118 introduces a zone-specific retention force for the first retention zone 112a that differs from that of another zone, e.g., the second retention zone 112b, that does not include the pin 118. For example, the substrate holder 110 may be a vacuum chuck that applies a retention pressure PR to a backside of the substrate 102. The pressure difference across the substrate 102 between the retention pressure PR and the ambient pressure P_{ambient} provides a force that holds the substrate 102 to the substrate holder 110. The extensible pin 118 provides a force to the substrate 102 that effectively overcomes the force of the pressure difference in a vicinity of the extensible pin 118. The force exerted by the extensible pin 118 deforms the substrate 102 toward the patterning tool 120 in a manner analogous to the deformation described above with respect to FIGS. 1 and 2A-2C. In essence, the extensible pin 118, when extended, produces a negative zone-specific retention force within the first retention zone 112a.

FIG. 5 illustrates a block diagram of a contact lithography system 200 according to an embodiment of the present invention. In particular, the contact lithography system 200 provides both alignment between a patterning tool and a substrate to be patterned and pattern transfer (e.g., imprinting) of the substrate with a pattern defined by the patterning tool. Furthermore, the contact lithography system 200 accomplishes both the alignment and the pattern transfer in a single setup or apparatus without a need to remove and/or transfer the patterning tool and the substrate after alignment from one setup or apparatus to another for pattern transfer, as in conventional systems.

The contact lithography system 200 comprises a contact mask aligner 210 and a contact lithography apparatus or module 220. The contact mask aligner 210 holds the contact lithography module 220 during both alignment and pattern transfer. The contact mask aligner 210 comprises a mask armature 212 and a substrate chuck or stage 214. In particular, the contact mask aligner 210 may be a conventional mask aligner with a substrate chuck or stage for holding a substrate and a mask armature for holding a mask blank. In the conventional mask aligner, the mask armature and the substrate chuck are movable relative to one another enabling the mask blank to be aligned to (e.g., x-y and/or rotational (ω) alignment) and then placed in contact (e.g., z-motion) with the substrate. However, the mask aligner 210 of the present invention differs from the conventional mask aligner in that the mask aligner 210 holds or supports the contact lithography module 220 of the present invention for pattern transfer, which is further described below. In some embodiments, the contact lithography module 220 is essentially similar to the contact lithography apparatus 100 described above. In other embodiments, the contact mask aligner 210 may be either a microscope with a movable stage or essentially any other apparatus that facilitates holding and movably positioning elements of the contact lithography module 220 for pattern transfer as described herein.

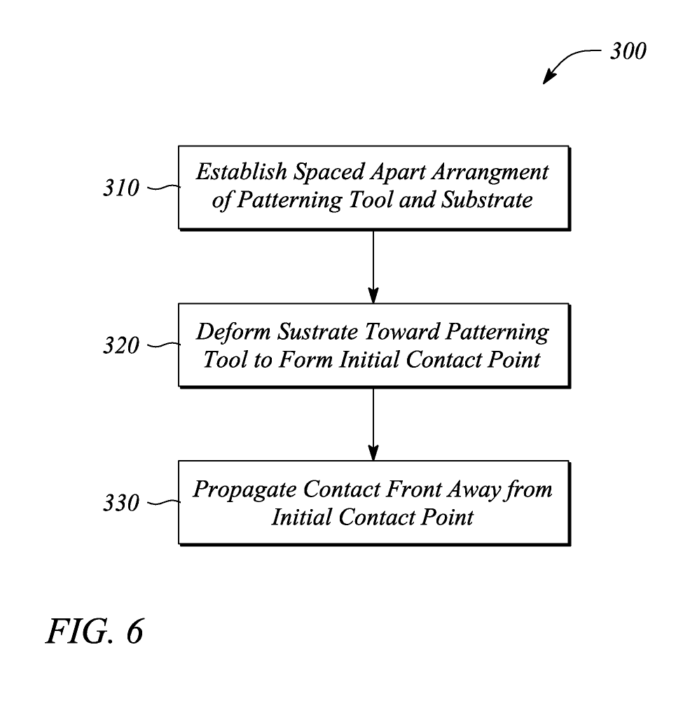

FIG. 6 illustrates a flow chart of a method 300 of transferring a pattern of a patterning tool to a surface of a substrate. The method 300 of transferring a pattern comprises establishing 310 a proximal, spaced apart arrangement of a patterning tool and a substrate being patterned (e.g., imprinted). In some embodiments, the patterning tool and the substrate are in a sealed chamber. For example, the sealed chamber may be the compressible chamber 130 described above with respect to the contact lithography apparatus 100. Establishing 310 a proximal, spaced apart arrangement may be essentially similar to that illustrated in and described with respect to FIG. 2A.

The method 300 of transferring a pattern further comprises deforming 320 the substrate toward the patterning tool to form an initial point of contact between the patterning tool and the substrate. Deforming 320 the substrate toward the patterning tool comprises reducing a retention force of a first zone of a substrate holder relative to a retention force of a second zone of the substrate holder. The substrate is positioned on the substrate holder. For example, the substrate holder may be essentially similar to the substrate holder 110 described above with respect to the contact lithography apparatus 100. Furthermore, deforming 320 the substrate toward the patterning tool may be essentially similar to that illustrated in and described with respect to FIG. 2C. In particular, the formed initial point of contact may be essentially similar to the initial contact point 140 described above.

In some embodiments, the retention force of the first zone is provided by a first retention pressure and the retention force of the second zone is provided by a second retention pressure. Deforming 320 the substrate toward the patterning tool further comprises establishing a pressure in the sealed chamber that is less than the first retention pressure. In other embodiments, deforming 320 the substrate toward the patterning tool comprises extending an extensible pin under the substrate, the pin extending the substrate toward the patterning tool. The extensible pin may be essentially similar to the extensible pin 118 describe above.

The method 300 of transferring a pattern further comprises propagating 330 a contact front away from the initial point of contact toward a perimeter of the substrate. The contact front is formed at an interface between the patterning tool and the substrate. The contact front propagates 330 to transfer the pattern of the patterning tool onto the substrate. In some embodiments, propagating 330 a contact front comprises reducing the retention force of the second zone. In some embodiments, propagating 330 a contact front comprises compressing the sealed chamber to reduce a spacing between the patterning tool and the substrate. In some embodiments, the compression of the sealed chamber is provided by a pressure difference between an interior and an exterior of the sealed chamber.

In some embodiments, the method 300 of transferring a pattern further comprises aligning (not illustrated) the patterning tool and the substrate using a contact mask aligner. In particular, the contact mask aligner establishes the proximal, space apart arrangement prior to deforming 320 the substrate toward the patterning tool and propagating 330 a contact front. In some embodiments, the contact mask aligner is similar to that illustrated in FIG. 5 and described above.

Thus, there have been described embodiments of an apparatus and a method of contact lithography that employ deformation of a substrate to facilitate pattern transfer during contact lithography. It should be understood that the above-described embodiments are merely illustrative of some of the many specific embodiments that represent the principles of the present invention. Clearly, those skilled in the art can readily devise numerous other arrangements without departing from the scope of the present invention as defined by the following claims.

What is claimed is:

1. A contact lithography apparatus comprising:
a substrate holder that variably retains a substrate, the substrate holder comprising a plurality of retention zones, each retention zone of the plurality imparting a zone-specific retention force to the substrate; and
a patterning tool having a pattern adjacent to a receiving surface of the substrate,
wherein the zone-specific retention forces imparted by the plurality of retention zones induce a deformation of the substrate toward the patterning tool, the deformation forming both an initial point of contact and a propagating contact front between the patterning tool and the substrate during transfer of the pattern to the substrate.

2. The contact lithography apparatus of claim 1, wherein a first retention zone of the plurality has a zone-specific retention force that is less than a zone-specific retention force of a second retention zone of the plurality, the initial point of contact being formed in a vicinity of the first retention zone.

3. The contact lithography apparatus of claim 2, wherein a pressure difference across the substrate at least at the first retention zone induces the deformation.

4. The contact lithography apparatus of claim 2, further comprising an extensible pin in the first retention zone, wherein extension of the pin further induces the deformation of the substrate.

5. The contact lithography apparatus of claim 1, further comprising a compressible chamber that encloses the patterning tool and the substrate, the chamber being compressed to transfer the pattern onto the substrate, the compressible chamber being compressed by a pressure difference between a pressure inside the chamber and a pressure outside the chamber, the pressure difference further inducing the deformation of the substrate.

6. The contact lithography apparatus of claim 5, wherein the compressible chamber comprises the patterning tool, the substrate holder and a compressible gasket, the compressible gasket being disposed to bridge between the patterning tool and the substrate.

7. The contact lithography apparatus of claim 1, wherein the zone-specific retention force is provided by a vacuum source.

8. The contact lithography apparatus of claim 1, further comprising a spacer disposed between the patterning tool and the substrate holder, the spacer limiting an extent to which the patterning tool and the substrate holder can approach one another during pattern transfer.

9. The contact lithography apparatus of claim 1 used in a contact mask aligner system, the contact lithography apparatus being affixed between alignment plates of the mask aligner, the mask aligner adjusting the contact lithography apparatus to align the patterning tool with the substrate, the affixed contact lithography apparatus transferring the pattern of the aligned patterning tool to the receiving surface of the aligned substrate.

10. The contact lithography apparatus of claim 1, wherein the retention zones essentially equally retain the substrate using similar zone-specific retention forces during an alignment of the substrate and the patterning tool, and wherein a retention force of a first retention zone of the plurality is reduced to deform the substrate toward the patterning tool to form the initial contact point, the contact front propagating from the initial contact point as the substrate and the patterning tool are moved closer to one another.

11. A contact lithography apparatus comprising:
a first plate that supports a patterning tool having a pattern;
a second plate spaced apart from the first plate, the second plate comprising a plurality of retention zones, the retention zones variably retaining a substrate to the second plate, the substrate having a receiving surface; and
a gasket that bridges a perimeter of a space between the first plate and the second plate to form a chamber with an internal cavity that encloses the patterning tool and the substrate, the chamber being compressible to transfer the pattern to the receiving surface such that the patterning tool is pressed against and contacts the substrate,
wherein the retention zones collectively induce a deformation of the substrate that results in an initial contact point between the patterning tool and the substrate, the initial contact point becoming a propagating contact front during chamber compression.

12. The contact lithography apparatus of claim 11, wherein the compressible chamber is compressed by a pressure difference between a pressure inside the chamber and a pressure outside the chamber.

13. The contact lithography apparatus of claim 12, wherein the pressure difference further induces the deformation of the substrate.

14. The contact lithography apparatus of claim 11, wherein the retention zones variably retain the substrate by retention pressure, each retention zone having a zone-specific retention pressure, a first retention zone having a lower zone-specific retention pressure than a second retention zone.

15. The contact lithography apparatus of claim 11 used in a contact mask aligner, the first plate being affixed to a first alignment plate of the mask aligner and the second plate being affixed to a second alignment plate of the mask aligner.

16. A method of transferring a pattern to a surface, the method comprising:
establishing a proximal, spaced apart arrangement of a patterning tool and a substrate;
deforming the substrate toward the patterning tool to form an initial point of contact between the patterning tool and the substrate, wherein deforming the substrate comprises reducing a retention force of a first zone of a substrate holder relative to a retention force of a second zone of the substrate holder; and
propagating a contact front between the patterning tool and the substrate, the contact front propagating away from the initial point of contact toward a perimeter of the substrate,
wherein the propagating contact front transfers the pattern of the patterning tool onto the substrate.

17. The method of transferring a pattern of claim 16, wherein the retention force of the first zone is provided by a first retention pressure and the retention force of the second zone is provided by a second retention pressure, deforming further comprising establishing a pressure in a sealed chamber that is less than the first retention pressure, the patterning tool and the substrate being in the sealed chamber.

18. The method of transferring a pattern of claim 17, wherein propagating the contact front comprises reducing the retention force of the second zone.

19. The method of transferring a pattern of claim 16, wherein propagating the contact front comprises compressing a sealed chamber containing the patterning tool and the substrate to reduce a spacing between the patterning tool and the substrate, compression being provided by a pressure difference between an interior of the sealed chamber and an exterior of the sealed chamber.

20. The method of transferring a pattern of claim 16, further comprising:
aligning the patterning tool and the substrate using a contact mask aligner, wherein the contact mask aligner establishes the proximal, space apart arrangement prior to deforming.
